(19) United States
(12) Patent Application Publication
(10) Pub. No.: US 2013/0250087 A1
(43) Pub. Date: Sep. 26, 2013

(54) PRE-PROCESSOR IMAGING SYSTEM AND METHOD FOR REMOTELY CAPTURING IRIS IMAGES

(71) Applicant: Peter A. Smith, San Antonio, TX (US)

(72) Inventor: Peter A. Smith, San Antonio, TX (US)

(21) Appl. No.: 13/428,835

(22) Filed: Mar. 23, 2012

(51) Int. Cl. H04N 7/18

(52) U.S. Cl. 348/78; 348/E07.085

(57) ABSTRACT

A pre-processor imaging system and method are disclosed for remotely capturing iris images of a target individual. In an embodiment, the pre-processor imaging system and method integrate an iris imaging system and a pre-processor that uses predictive head and eye tracking algorithms to predict a maximal opportunity window for capturing iris images. An embodiment of the pre-processor directs the iris imaging system to capture the iris images within the maximal opportunity window. In an embodiment, the iris imaging system includes a zoom camera and an infrared illumination system for reliably obtaining high-resolution iris images of each eye/iris region of the target individual, and while the target individual is “on-the-move.”

### BACKGROUND

Iris recognition is important in multi-modal biometrics programs, but its use is limited by constraints on technology for capturing iris images. Currently, iris-based biometrics is confined to conditions that optimize obtaining high-resolution, high-contrast images. These conditions include careful positioning of a cooperative person willing to keep their head still and look into a limited field of view capture camera with suitable illumination. Typical systems require the person to be within 50 cm from the sensor and to remain stationary for up to ten seconds in-line with the scanning window. As a consequence, iris recognition systems have a reputation for being borderline intrusive, and less friendly for both subjects and operators. For some applications, such as security checkpoints, bank teller machines, or information technology (IT) access points, these limitations are acceptable. However, these constraints limit practical use for many applications, such as screening in airports, subway systems or at entrances to uncontrolled facilities where persons are moving and not visually fixated at one point. What is needed is a system that captures iris images while the person is in motion and at a substantial distance from a sensor.

### DESCRIPTION OF THE DRAWINGS

The detailed description will refer to the following drawings, wherein like numerals refer to like elements, and wherein:

FIG. 1 illustrates an embodiment of a pre-processor imaging system for remotely capturing iris images;

FIG. 2 illustrates an overall system architecture of an embodiment of a pre-processor imaging system;

FIG. 3 illustrates exemplary screenshots generated by an application program interface (API) showing face detection, eye position and head pose tracking;

FIG. 4 is a flow chart illustrating embodiment of a method for using the pre-processor imaging system of FIG. 2 to remotely capture iris images; and

FIG. 5 is a block diagram illustrating exemplary hardware components for implementing embodiments of the pre-processor imaging system of FIG. 2 and method of FIG. 4 for remotely capturing iris images.

### DETAILED DESCRIPTION

A pre-processor imaging system and method are disclosed for remotely capturing iris images of a target individual (i.e., subject or capture subject). In an embodiment, the pre-processor imaging system and method integrate an iris imaging system and a pre-processor that uses predictive head and eye tracking algorithms to predict a maximal opportunity window (i.e., optimal opportunity window) for capturing iris images. An embodiment of the pre-processor directs the iris imaging system to capture the iris images within the maximal opportunity window. In an embodiment, the iris imaging system includes a zoom camera and an infrared illumination system for reliably obtaining high-resolution iris images of each eye/iris region of the target individual, while the target individual is “on-the-move.”

An embodiment of the infrared illumination system uses a high-intensity infrared light source to illuminate eyes of the target individual to obtain high-speed images and reduce motion blur. An embodiment of the pre-processor imaging system and method uses bandwidth filters to eliminate noise from ambient light. An embodiment of the pre-processor may use a three-dimensional (3-D) head-eye position model to provide 3-D head and eye tracking. The integrated pre-processor imaging system, also referred to as an iris-capture breadboard, may serve as a platform for capturing iris images in moving subjects not fixating on the camera.

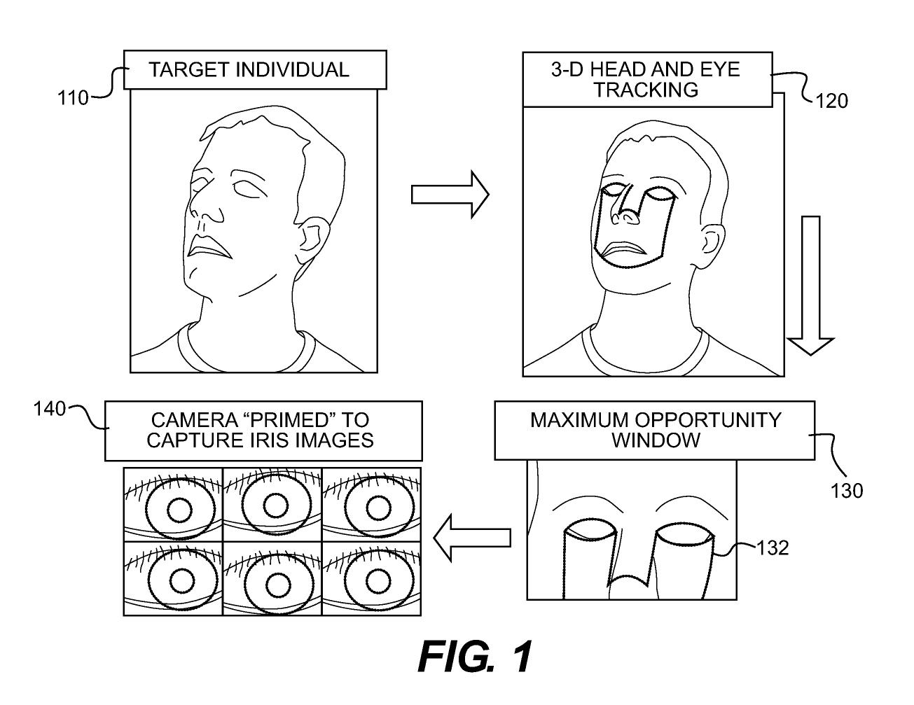

FIG. 1 illustrates an embodiment of a pre-processor imaging system for remotely capturing iris images. The pre-processor imaging system may provide 3-D head and eye tracking 120 of a target individual 110 to predict a maximal opportunity window 130 (i.e., optimal downstream iris-capture opportunity). The pre-processor imaging system may include one or more cameras primed to capture iris images 140. The pre-processor imaging system optimizes the iris-capture opportunity, improves failure-to-acquire rates, and provides less intrusive and less constrained iris image acquisition by capturing iris images while the subjects are moving or uncooperative.

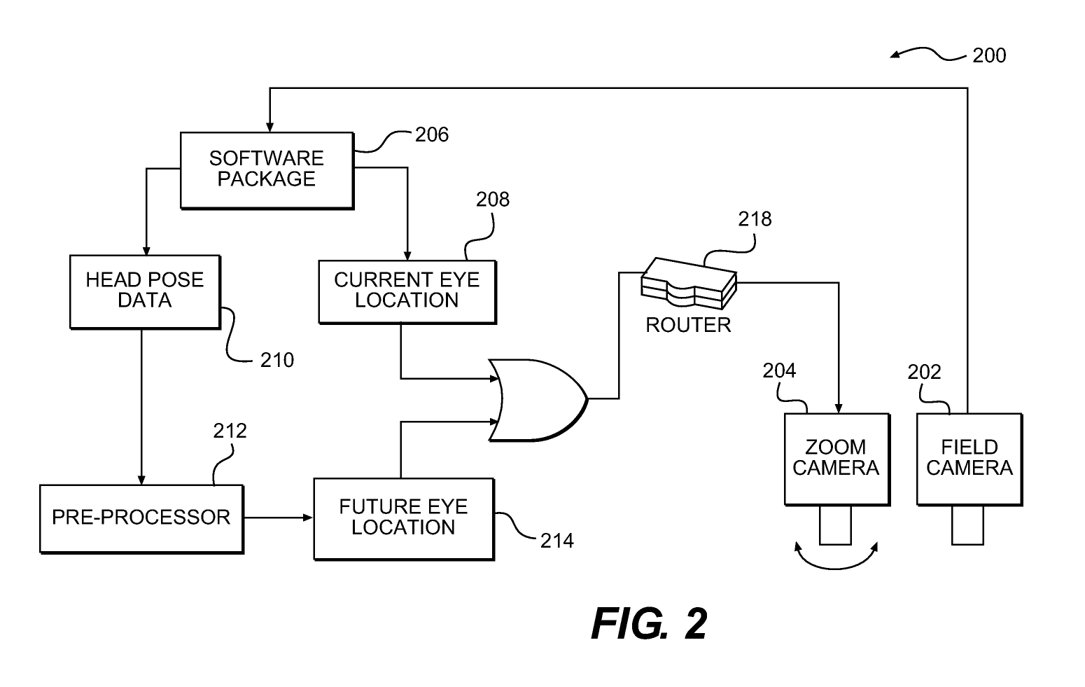

FIG. 2 illustrates an overall system architecture of an embodiment of a pre-processor imaging system 200. The pre-processor imaging system 200 may use a field camera 202, such as an inexpensive webcam, to observe the target individual 110 (i.e., subject or capture subject). The output of the field camera 202 may be fed to a software package 206 that determines a current eye location 208 and head-pose data 210. The current eye location 208 may be the position of the eyes in a 3-D space. The head-pose data 210 may be the position and rotation of the head in space relative to the field camera 202.

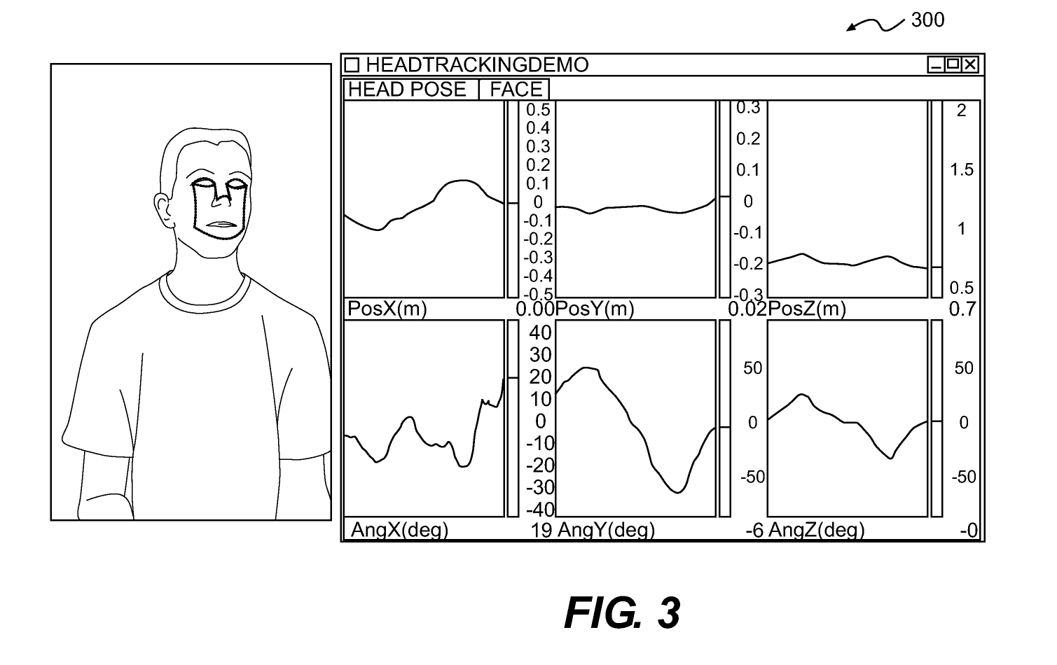

The software package 206 may be an application program interface (API), such as faceAPI™, that implements a face detection algorithm, eye position detector, and a head pose estimator to determine the current eye location 208 and the head-pose data 210. FIG. 3 illustrates exemplary screenshots 300 generated by the API, such as faceAPI™, showing face detection, eye position and head pose tracking.

In the absence of a predictive algorithm, the current eye location 208 may be used to position a second, a zoom camera 204 (i.e., eye camera) to capture the iris images. The zoom camera 204 may be part of an iris imaging system (not shown) and may be a high quality zoom camera. The current eye location 208 may also be used to provide baseline information regarding acquisition rates. The baseline information may be iris-capture acquisition rates that the system captures an iris image considering lags in the positioning system, including video frame lags, eye position and head pose detection, and camera re-positioning.

The head-pose data 210 and the current eye location 208 may be used as inputs to a pre-processor 212 that uses a head movement model (e.g., predictive head and eye tracking algorithms) to predict a future eye location 214, e.g., the location of the iris at a future point in time and space, and identify the maximal opportunity window 130 for iris-capture. In other words, the head-pose data 210 and the current eye location 208 are used by the pre-processor 212 to drive the zoom camera 204 to improve iris acquisition rates.

The head-pose data 210 and the current eye location 208 may provide historical data on the head movement pattern (i.e., head movement pattern data). The pre-processor 212 may use video imagery from the field camera 202 and head and eye movement behavioral characteristics to identify the maximal opportunity window 130 for iris-capture. The head and eye movement behavioral characteristics may be obtained by analyzing facial features and the head movement pattern data using, for example, the predictive head and eye tracking algorithms.

Examples of the predictive head and eye tracking algorithms include algorithms described in Three-Dimensional Model of the Human Eye-Head Saccadic System, by Douglas Tweed, The Journal of Neurophysiology Vol. 77 No. 2 February 1997, pp. 654-666, which is incorporated herein by reference. Alternate algorithms, based on similar approaches, or more simple control laws may also be used. The predictive head and eye tracking algorithms may predict the future eye location 214 and the next maximal opportunity window 130 for iris-capture. The maximal opportunity window 130 may be used to direct the zoom camera 204 to obtain close-up, high-resolution images of a rectangular region 132 (shown in FIG. 1) that contains both eyes of the target individual 110.

The predictive head and eye tracking algorithms may be provided in Matlab form and ported to Mathcad to test in an embodiment. In an embodiment, the Mathcad may be converted to C++. The pre-processor 212 may provide an integration tool that allows the output data, which is expressed as 3-D rotations of the head and eye in quaternion form, to be readily visualized. Quaternion form is a set of numbers that include a four-dimensional vector space with a basis including the real number 1 and three imaginary units i. j, k, that follow special rules of multiplication and that are used in computer graphics, robotics, and animation to rotate objects in three dimensions. The predictive head and eye tracking algorithms may predict the head and eye movements when a target individual moves from looking at a known fixed position (the starting position) to another known position (the target position). Both these positions may be provided as input data to explore the dynamics of head and eye movements, e.g., head movement pattern data. The head movement pattern data may be used as an input to predict the likely next movement in terms of magnitude and direction.

With reference to FIG. 2 again, the pre-processor 212 may provide a scalable system that develops, tests, and tunes the predictive head and eye tracking algorithms to enhance iris-capture. For example, the predictive head and eye tracking algorithms may use the head movement pattern data to predict the future eye location 214 to position customized optical systems, such as the iris imaging system that includes the zoom camera 204, to capture the iris images.

The pre-processor 212 may use non-contact, optical methods to measure eye motion based on, for example, light reflected from the eyes and sensed by the field camera 202. The reflected light may be analyzed by the pre-processor 212 to extract eye rotation information based on changes in reflections. Also, a gaze direction may be predicted based on the visual environment. For example, people look at regular patterns more frequently than random patterns. Likewise, at airport security checkpoints, prior to the personal screener, passengers often look up to see if the green light is on. The pre-processor 212 may conduct an analysis of the visual environment to determine the likely salient features to guide system placement to optimize the observation point and may purposefully install salient features in the environment to attract attention.

Having identified the maximum opportunity window 130 that includes the future eye location 214, the zoom camera 204 may be directed to take a sequence of close-up, high-resolution images of each eye/iris region to be used by iris recognition algorithms. High-intensity infrared light sources (not shown) may be used to provide sufficient illumination to obtain high-speed images with the zoom camera 204. Bandwidth filters (not shown) may be used to eliminate noise from ambient light.

The zoom camera 204 may be, for example, a Sony Ipela pan, tilt and zoom (PTZ) network camera that aims at the eyes and captures the iris images, or a video camera directed through an X-Y steering mirror director system. The current eye location 208 may be extracted from data stream provided by the software package 206, and fed to the zoom camera 204 through the pre-processor 212 on a frame by frame basis, for example, at 30 frames per second. The communication between the pre-processor and the zoom camera 204 may be through a direct drive protocol.

Embodiments of pre-processor imaging system 200 provide predictive head and eye movement models to enhance the capturing of iris images from target individuals in close open space, potentially without their knowledge. This technology has a wide variety of applications in a number of markets, including access control, identity services, and surveillance for airports, border control, government, military, and intelligence facilities. Face recognition systems may also benefit from the pre-processor imaging system, which may be used to anticipate when a face will be orthogonal to the camera, and thereby optimal for face capture.

Embodiments of pre-processor imaging system 200 may have applications outside the biometrics market. For instance, the human-machine interfacing challenges presented by video teleconferencing and in virtual worlds and gaming may benefit from this technology. The pre-processor imaging system 200 may be used to enhance the generation of synthetic images used to improve eye contact using stereo reconstruction techniques by anticipating head orientation for future frames, and may be used to enhance applications that seek to paint a webcam video of a participant's face onto an avatar in virtual worlds. In addition, by tracking and following the head movements of an individual, the pre-processor imaging system 200 may isolate suspicious behaviors or activities on the basis that the movement does not align with the major models of movement developed for this individual.

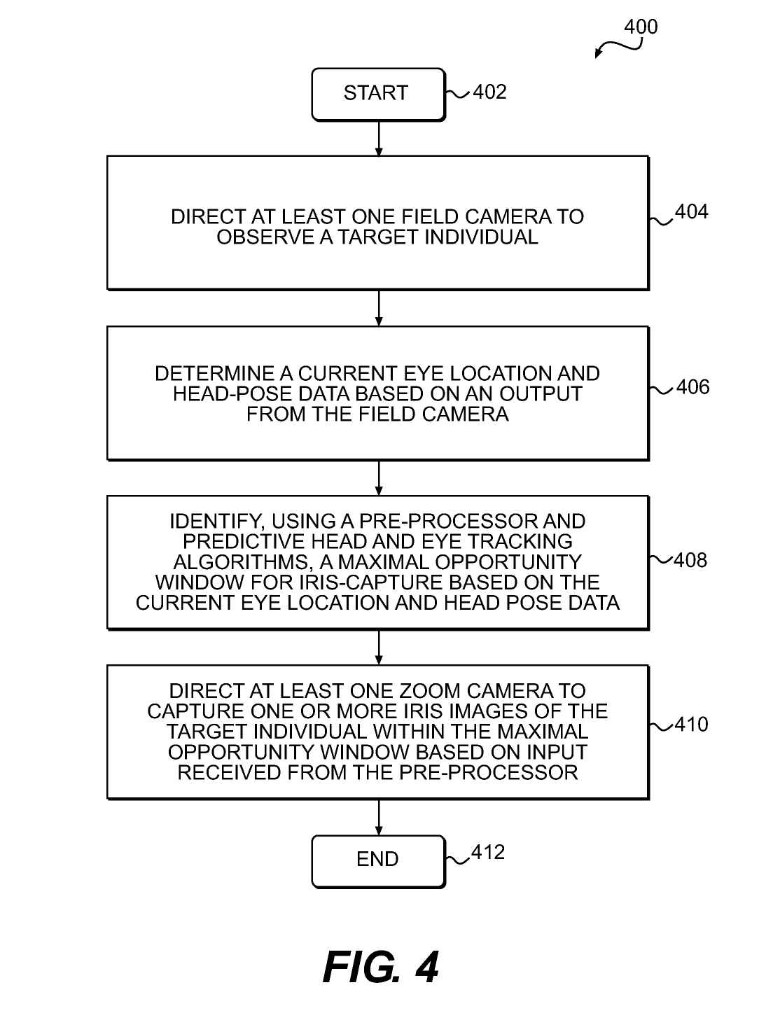

FIG. 4 is a flow chart illustrating embodiment of a method 400 for using the pre-processor imaging system 200 to remotely capture iris images. The method 400 starts (block 402) by directing at least one field camera to observe a target individual (block 404). Next, the method 400 determines a current eye location and head-pose data based on an output from the field camera (block 406). Then method 400 then identifies, using a pre-processor and predictive head and eye tracking algorithms, a maximal opportunity window for iris-capture (block 408). Finally, the method 400 directs at least one zoom camera to capture one or more iris images of the target individual within the maximal opportunity window (block 410) and ends at block 412.

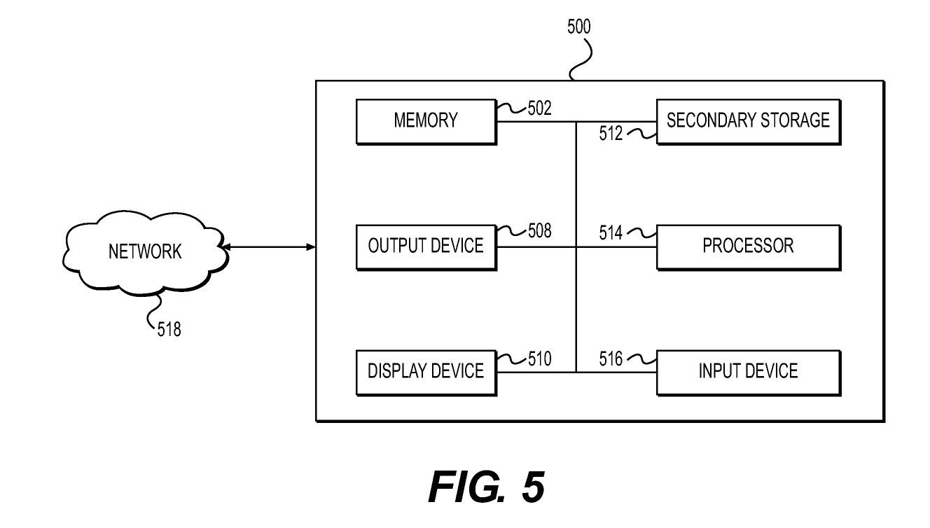

FIG. 5 is a block diagram illustrating exemplary hardware components for implementing embodiments of the pre-processor imaging system 200 and method 500 for remotely capturing iris images. A server 500, or other computer system similarly configured, may include and execute programs to perform functions described herein, including steps of method 500 described above. Likewise, a mobile device that includes some of the same components of the computer system 500 may perform steps of the method 400 described above. The computer system 500 may connect with a network 518, e.g., Internet, or other network, to receive inquires, obtain data, and transmit information and incentives as described above.

The computer system 500 typically includes a memory 502, a secondary storage device 512, and a processor 514. The computer system 500 may also include a plurality of processors 514 and be configured as a plurality of, e.g., bladed servers, or other known server configurations. The computer system 500 may also include an input device 516, a display device 510, and an output device 508. The memory 502 may include RAM or similar types of memory, and it may store one or more applications for execution by the processor 514. The secondary storage device 512 may include a hard disk drive, floppy disk drive, CD-ROM drive, or other types of non-volatile data storage. The processor 514 executes the application(s), such as the software package 206, which are stored in the memory 502 or the secondary storage 512, or received from the Internet or other network 518. The processing by the processor 514 may be implemented in software, such as software modules, for execution by computers or other machines. These applications preferably include instructions executable to perform the functions and methods described above and illustrated in the Figures herein. The applications preferably provide GUIs through which users may view and interact with the application(s), such as the software package 206.

Also, as noted, the processor 514 may execute one or more software applications in order to provide the functions described in this specification, specifically to execute and perform the steps and functions in the methods described above. Such methods and the processing may be implemented in software, such as software modules, for execution by computers or other machines. The GUIs may be formatted, for example, as web pages in Hyper-Text Markup Language (HTML), Extensible Markup Language (XML) or in any other suitable form for presentation on a display device depending upon applications used by users to interact with the pre-processor imaging system 200.

The input device 516 may include any device for entering information into the computer system 500, such as a touch-screen, keyboard, mouse, cursor-control device, microphone, digital camera, video recorder or camcorder. The input device 516 may be used to enter information into GUIs during performance of the methods described above. The display device 510 may include any type of device for presenting visual information such as, for example, a computer monitor or flat-screen display (or mobile device screen). The display device 510 may display the GUIs and/or output from the software package 206, for example. The output device 508 may include any type of device for presenting a hard copy of information, such as a printer, and other types of output devices include speakers or any device for providing information in audio form.

Examples of the computer system 500 include dedicated server computers, such as bladed servers, personal computers, laptop computers, notebook computers, palm top computers, network computers, mobile devices, or any processor-controlled device capable of executing a web browser or other type of application for interacting with the system.

Although only one computer system 500 is shown in detail, the pre-processor imaging system 200 may use multiple computer systems or servers as necessary or desired to support the users and may also use back-up or redundant servers to prevent network downtime in the event of a failure of a particular server. In addition, although the computer system 500 is depicted with various components, one skilled in the art will appreciate that the server can contain additional or different components. In addition, although aspects of an implementation consistent with the above are described as being stored in memory, one skilled in the art will appreciate that these aspects can also be stored on or read from other types of computer program products or computer-readable media, such as secondary storage devices, including hard disks, floppy disks, or CD-ROM; or other forms of RAM or ROM. The computer-readable media may include instructions for controlling a computer system, such as the computer system 500, to perform a particular method, such as methods described above.

The terms and descriptions used herein are set forth by way of illustration only and are not meant as limitations. Those skilled in the art will recognize that many variations are possible within the spirit and scope of the invention as defined in the following claims, and their equivalents, in which all terms are to be understood in their broadest possible sense unless otherwise indicated.

What is claimed is:

1. A pre-processor imaging system for remotely capturing iris images, comprising:
at least one field camera that observes a target individual;
tracking software that receives and processes an output from the field camera and determines a current eye location and head-pose data based on the processed output;
a pre-processor that receives the current eye location and head-pose data and uses predictive head and eye tracking algorithms to identify a maximal opportunity window for iris-capture based on the current eye location and head-pose data; and
an iris imaging system including at least one zoom camera for capturing one or more iris images of the target individual within the maximal opportunity window based on input received from the pre-processor and the tracking software.

2. The system of claim 1, wherein the current eye location is a position of eyes of the target individual in a three-dimensional (3-D) space.

3. The system of claim 1, wherein the head-pose data is a position and rotation of a head of the target individual in space relative to the field camera.

4. The system of claim 1, wherein the software includes an application program interface (API) that implements a face detection algorithm, an eye position detector, and a head pose estimator to determine the current eye location and the head-pose data.

5. The system of claim 1, wherein the head-pose data provides head movement pattern data, and wherein the pre-processor may use video imagery from the field camera and head and eye movement behavioral characteristics to identify the maximal opportunity window for iris-capture.

6. The system of claim 5, wherein the head and eye movement behavioral characteristics are obtained by analyzing facial features and the head movement pattern data using the predictive head and eye tracking algorithms

7. The system of claim 5, wherein the head movement pattern data is used as an input to predict a likely next movement in terms of magnitude and direction.

8. The system of claim 1, wherein the predictive head and eye tracking algorithms predict head and eye movements when the target individual moves from looking at a known fixed position to another known position.

9. The system of claim 1, wherein the pre-processor uses the predictive head and eye tracking algorithms to predict a future eye location.

10. The system of claim 1, wherein the pre-processor uses non-contact, optical methods to measure eye motion based on light reflected from eyes of the target individual and sensed by the field camera.

11. The system of claim 10, wherein the pre-processor analyzes the reflected light to extract eye rotation information based on changes in reflections.

12. The system of claim 1, wherein the pre-processor predicts a gaze direction based on a visual environment.

13. The system of claim 1, wherein the zoom camera takes a sequence of close-up, high-resolution images of each eye region of the target individual.

14. The system of claim 1, wherein the iris imaging system further includes high-intensity infrared lights sources to provide illumination to obtain high-speed images with the zoom camera.

15. The system of claim 1, wherein the iris imaging system further includes bandwidth filters to eliminate noise from ambient light.

16. The system of claim 1, wherein the zoom camera is a camera that aims at eyes of the target individual and captures the iris images.

17. The system of claim 1, wherein the zoom camera is a video camera directed through an X-Y steering mirror director system.

18. The system of claim 1, wherein the current eye location is extracted from a data stream provided by the software package, and fed to the zoom camera on a frame by frame basis at 30 frames per second.

19. The system of claim 1, wherein the communication between the pre-processor and the zoom camera may be through a direct drive protocol.

20. A method for remotely capturing iris images using a pre-processor imaging system, comprising:
directing at least one field camera to observe a target individual;
determining a current eye location and head pose date based on an output from the field camera;
identifying, using a pre-processor and predictive head and eye tracking algorithms, a maximal opportunity window for iris-capture based on the current eye location and head pose data; and
directing at least one zoom camera to capture one or more iris images of the target individual within the maximal opportunity window based on input received from the pre-processor.

21. A computer readable medium providing instructions for remotely capturing iris image using a pre-processor imaging system, the instructions comprising:
directing at least one field camera to observe a target individual;
determining a current eye location and head pose date based on an output from the field camera;
identifying, using a pre-processor and predictive head and eye tracking algorithms, a maximal opportunity window for iris-capture based on the current eye location and head pose data; and
directing at least one zoom camera to capture one or more iris images of the target individual within the maximal opportunity window based on input received from the pre-processor.
